(19) United States
(12) Patent Application Publication
(10) Pub. No.: US 2018/0301078 A1
(43) Pub. Date: Oct. 18, 2018

(54) METHOD AND DUAL SCREEN DEVICES FOR DISPLAYING TEXT

(71) Applicants: HISENSE MOBILE COMMUNICATIONS TECHNOLOGY CO., LTD., Qingdao (CN); HISENSE USA CORPORATION, Suwanee, GA (US); HISENSE INTERNATIONAL CO., LTD., Qingdao (CN)

(72) Inventors: Wei Zhou, Qingdao (CN); Qiang Zhang, Qingdao (CN)

(21) Appl. No.: 16/016,049

(22) Filed: Jun. 22, 2018

(30) Foreign Application Priority Data
Jun. 23, 2017 (CN) 201710485776.0

(51) Int. Cl. G09G 3/20; G09G 3/34

(52) U.S. Cl. CPC G09G 3/2007; G09G 2320/0666; G09G 3/344

(57) ABSTRACT

The disclosure discloses methods and dual-screen devices for displaying text. The method includes: obtaining a red-green-blue (RGB) value of a pixel of the text displayed on a color display screen of the dual-screen device; determining a first grayscale value of the text according to the RGB value; determining a second grayscale value of a background for the text, where the second grayscale value is different from the first grayscale value; displaying the text on an e-ink screen of the dual-screen device according to the first grayscale value and displaying the background surrounding the text on the e-ink screen according to the second grayscale value.

### CROSS-REFERENCE TO RELATED APPLICATIONS

This application claims priority to Chinese Patent Application No. CN201710485776.0, filed on Jun. 23, 2017, the content of which is hereby incorporated by reference in its entirety.

### FIELD

This disclosure relates to image processing, and particularly to methods and dual-screen devices for displaying text.

### BACKGROUND

Electronic technology is growing rapidly with the continuous development of science and technology, and more and more types of electronic products are emerging. For example, through various types of mobile devices, one can enjoy the comfortable life brought by the development of science and technology. As an e-ink screen is a kind of display screen with low power consumption, people are becoming more interested in mobile devices with e-ink screens. Accordingly, there is a need to display text on the e-ink screen of a device, such as a mobile device, in a better way.

### SUMMARY

Embodiments of the disclosure provide methods, dual-screen devices, and storage media for displaying text.

Some embodiments of the disclosure provide a method for displaying text on a dual-screen device, including: obtaining a red-green-blue (RGB) value of a pixel of the text displayed on a color display screen of the dual-screen device, wherein the dual-screen device includes a main body, the color display screen on a first surface of the main body, and an e-ink screen on a second surface, opposite to the first surface, of the main body; determining a first grayscale value of the text according to the RGB value; determining a second grayscale value of a background for the text, where the second grayscale value is different from the first grayscale value; displaying the text on the e-ink screen according to the first grayscale value and displaying the background surrounding the text on the e-ink screen according to the second grayscale value.

Some embodiments of the disclosure provide a dual-screen device, the dual-screen device includes a main body, a color display screen on a first surface of the main body, and an e-ink screen on a second surface, opposite to the first surface, of the main body; where the dual-screen device further includes a processor and a memory storing computer programs, and the processor is configured to execute the computer programs to: obtain an RGB value of a pixel of text displayed on the color display screen; determine a first grayscale value of the text according to the RGB value; determine a second grayscale value of a background for the text, where the second grayscale value is different from the first grayscale value; display the text on the e-ink screen according to the first grayscale value and display the background surrounding the text on the e-ink screen according to the second grayscale value.

Some embodiments of the disclosure provide a computer readable non-transitory storage medium including computer codes, where the computer codes are configured to enable a processor of a dual-screen device to execute operations of the method for displaying the text according to the embodiments of the disclosure when the computer codes run on the processor of the dual-screen device; where the dual-screen device includes a main body, a color display screen on a first surface of the main body, and an e-ink screen on a second surface, opposite to the first surface, of the main body.

Some embodiments of the disclosure provide a method for displaying a character on a dual-screen device, including: obtaining a red-green-blue (RGB) value of a pixel of the character displayed on a color display screen of the dual-screen device, wherein the dual-screen device includes a main body, the color display screen on a first surface of the main body, and an e-ink screen on a second surface, opposite to the first surface, of the main body; determining a first grayscale value of the character according to the RGB value; determining a second grayscale value of a frame for the character, where the second grayscale value is different from the first grayscale value; displaying the character on the e-ink screen according to the first grayscale value and displaying the frame surrounding the character on the e-ink screen according to the second grayscale value.

Some embodiments of the disclosure provide a dual-screen device, the dual-screen device includes a main body, a color display screen on a first surface of the main body, and an e-ink screen on a second surface, opposite to the first surface, of the main body; where the dual-screen device further includes a processor and a memory storing computer programs, and the processor is configured to execute the computer programs to: obtain an RGB value of a pixel of a character displayed on the color display screen; determine a first grayscale value of the character according to the RGB value; determine a second grayscale value of a frame for the character, where the second grayscale value is different from the first grayscale value; display the character on the e-ink screen according to the first grayscale value and display the frame surrounding the character on the e-ink screen according to the second grayscale value.

Some embodiments of the disclosure provide a computer readable non-transitory storage medium including computer codes, where the computer codes are configured to enable a processor of a dual-screen device to execute operations of the method for displaying the character according to the embodiments of the disclosure when the computer codes run on the processor of the dual-screen device; where the dual-screen device includes a main body, a color display screen on a first surface of the main body and an e-ink screen on a second surface, opposite to the first surface, of the main body.

It shall be understood that the general descriptions above and the detailed descriptions below are exemplary and explanatory only and do not limit the content of the disclosure.

### BRIEF DESCRIPTION OF THE DRAWINGS

In order to make the embodiments of the disclosure more apparent, the drawings to which a description of the embodiments refers will be briefly introduced below. The drawings to be described below are merely illustrations of the embodiments of the disclosure, and those of ordinarily skilled in the art can derive other embodiments from these drawings without undue experimentation.

FIG. 1 shows a flow chart of a method for displaying a character on a dual-screen device according to the embodiments of the disclosure;

FIG. 2 shows a flow chart of another method for displaying a character on a dual-screen device according to the embodiments of the disclosure;

FIG. 3 shows a display interface of an e-ink screen of a dual-screen device performing a method for displaying a character according to the embodiments of the disclosure;

FIG. 4 shows a schematic structural diagram of a dual-screen device according to the embodiments of the disclosure;

FIG. 5 shows a schematic structural diagram of a character display device of a dual-screen device according to the embodiments of the disclosure;

FIG. 6 shows a schematic structural diagram of a second obtaining module according to the embodiments of the disclosure; and

FIG. 7 shows a schematic structural diagram of a first obtaining module according to the embodiments of the disclosure.

Embodiments of the disclosure are explicitly illustrated in the above-mentioned drawings and are described in more detail below. These drawings and textual descriptions are not intended to limit the scope of the disclosure in any way, but rather explain to those skilled in the art the concepts of the disclosure by referring to particular embodiments.

### DETAILED DESCRIPTION

Text intended to be displayed in color is often displayed with the same brightness on an e-ink screen of a device (in grayscale). In one example, when the color of the characters in the text is blue, the determined grayscale value of the characters is likely to be approximately the same as a grayscale value of the background color of the e-ink screen.

Since the grayscale value of the text is approximately the same as the grayscale value of the background color of the e-ink screen, grayscale levels of the text and the background color of the e-ink screen are similar or the same, causing the displayed text to be unclear or even unable to be identified, which is not desired.

In order to improve clarity of the text displayed on the e-ink screen and improve display effects of the dual-screen mobile device, embodiments of the disclosure provide methods for displaying text on a dual-screen device, associated dual-screen devices, and associated computer readable non-transitory storage media. The depicted dual-screen device includes a main body, a color display screen on a first surface of the main body, and an e-ink screen on a second surface, opposite to the first surface, of the main body. The depicted method includes the following operations: obtaining a red-green-blue (RGB) value of a pixel of text displayed on the color display screen; determining a first grayscale value of the text according to the RGB value; determining a second grayscale value of a background for the text, where the second grayscale value is different from the first grayscale value; displaying the text on the e-ink screen according to the first grayscale value and displaying the background surrounding the text on the e-ink screen according to the second grayscale value.

To make advantages of the embodiments of the disclosure clearer, the disclosure is described below in details with reference to the drawings. It shall be understood that the detailed descriptions below are exemplary and explanatory only and do not limit the content of the disclosure. For example, although the detailed descriptions below discuss the treatment of characters and their associated frames, it will be understood that one or more characters can also be treated collectively as text, and the associated frame(s) can be treated together as a background in the same manner.

In some embodiments, text refers to one or more characters, or one or more letters, or one or more words.

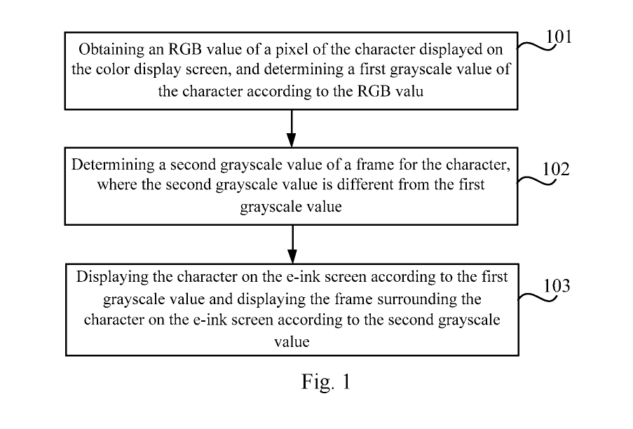

The embodiments of the disclosure provide a method for displaying a character on a dual-screen device. The dual-screen device includes a main body, a color display screen on a first surface of the main body, and an e-ink screen on a second surface opposite to the first surface of the main body. As illustrated in FIG. 1, the method includes the following operations.

Operation 101: obtaining an RGB value of a pixel of the character displayed on the color display screen, and determining a first grayscale value of the character according to the RGB value.

Operation 102: determining a second grayscale value of a frame for the character, where the second grayscale value is different from the first grayscale value.

Operation 103: displaying the character on the e-ink screen according to the first grayscale value and displaying the frame surrounding the character on the e-ink screen according to the second grayscale value.

In the method for displaying the character on the dual-screen device according to some embodiments of the disclosure, the first grayscale value of the character and the second grayscale value of the frame for the character are obtained, the character is displayed on the e-ink screen according to the first grayscale value, and the frame for the character is displayed surrounding the character on the e-ink screen according to the second grayscale value. Since the second grayscale value is different from the first grayscale value, grayscale levels of the character and the frame are different, avoiding ambiguity of the displayed character caused by similarity or consistency of the grayscale levels of the character and the background color, improving clarity of the character displayed on the e-ink screen and the display effects of the dual-screen device.

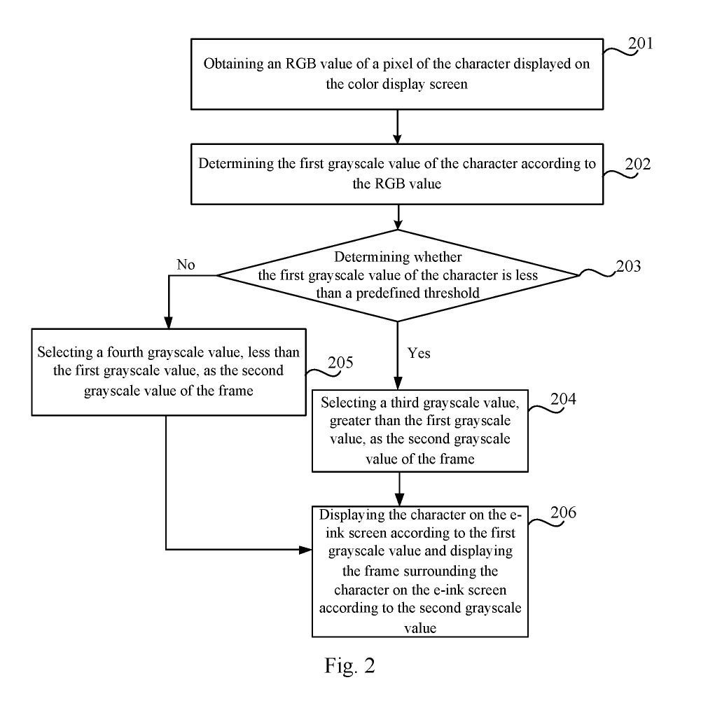

The embodiments of the disclosure further provide another method for displaying a character on a dual-screen device. The dual-screen device includes a main body, a color display screen on a first surface of the main body, and an e-ink screen on a second surface opposite to the first surface of the main body. As illustrated in FIG. 2, the method includes the following operations.

Operation 201: obtaining an RGB value of a pixel of the character displayed on the color display screen.

In some embodiments, the dual-screen device obtains an RGB value of any pixel of the character via an application programming interface (API) provided by an operating system for an application configured to draw and display characters. In some embodiments, the operating system of the dual-screen device is an Android operating system, and the embodiments of the disclosure are described using an Android operating system as an example operating system of the dual-screen device.

The dual-screen device determines a grayscale value of the character (i.e. a first grayscale value) according to the RGB value of a pixel of the character, which means that the device performs grayscale processing on an image of the character. A color of a pixel of the character is usually determined by values of a red component, a green component and a blue component thereof, where a range of a value of each component is usually 0-255. Further, a range of the determined grayscale value of the character is usually 0-255.

In one example, the character occupies n1 pixels (n1>1), and the dual-screen device obtains an RGB value of any one of the n1 pixels. As an example, a value of an R component of one pixel among the n1 pixels is x1, a value of a G component of the pixel is y1, and a value of a B component is z1, where 0<x1<255, 0<y1<255, 0<z1<255.

It shall be noted that, an RGB value of a pixel is usually obtained by converting an RGBA value of the pixel into the RGB value after obtaining the RGBA value, where “A” (short for Alpha) in “RGBA” represents transparency.

Operation 202: determining the first grayscale value of the character according to the RGB value.

In some embodiments, the dual-screen device determines the first grayscale value of the character according to the RGB value by adopting a weighted average method, a mean value method, or a maximum value method; where the weighted average method has a higher precision than other methods.

The weighted average method refers to assigning different weights to values of the R, G, and B components of the pixel and then calculating a mean of the weighted values as the first grayscale value of the character. Since human eyes have different levels of sensitivity to the red, green and blue colors, by averaging the values of the three components of the pixel with different weights one can obtain a reasonable grayscale image. Moreover, since human eyes are more sensitive to the green color and less sensitive to the blue color, in some embodiments, when the first grayscale value of the character is determined via the weighted average method, a weight for the G component is generally greater than a weight for the R component, and the weight for the R component is generally greater than a weight for the B component, to obtain a more reasonable grayscale image.

In some embodiments, the dual-screen device determines the first grayscale value of the character according to the RGB value according to a formula (1) below.

Gray=R*0.299+G*0.587+B*0.114 (1)

In formula (1), Gray represents the first grayscale of the character, R represents the value of the R component of the pixel, G represents the value of the G component of the pixel, B represents the value of the B component of the pixel; and 0.299, 0.587 and 0.114 are the weights for the three components respectively.

In some embodiments, to avoid low-speed floating point operations, the first grayscale value of the character may be determined according to the RGB value by formula (2) below.

Gray=(R*299+G*587+B*114+500)/1000 (2)

Formula (3) is an approximation of the formula (2) and the dual-screen device may determine the first grayscale value of the character according to the RGB value by formula (3) below.

Gray=(R*30+G*59+B*11+50)/100 (3)

In some embodiments, to increase the operation rate, the division operation in formulas (2) and (3) may be replaced by a shift operation to obtain formula (4). The dual-screen device may further determine the first grayscale value of the character according to the RGB value by formula (4) below.

Gray=(R*19595+G*38469+B*7472)>>16 (4)

Where Gray in formulas (2) to (4) represents the first grayscale value of the character, R represents the value of the R component of the pixel, G represents the value of the G component of the pixel, B represents the value of the B component of the pixel, “>>” in formula (4) is a right shift operator, and “500” in formula (2) and “50” in formula (3) are added for the purpose of rounding-off, since the division operation in formulas (2) and (3) is an integer division operation.

In addition, accuracy of the weights in formula (4) can also be modified so that the weights have a precision of 2 to 20 bits. This yields the following formulas that include a shift operator. The dual-screen device may determine the first grayscale value of the character according to the RGB value by any one of the following formulas including the shift operator.

Gray=(R*2+G*5+B*1)>>3

Gray=(R*4+G*10+B*2)>>4

Gray=(R*9+G*19+B*4)>>5

Gray=(R*19+G*37+B*8)>>6

Gray=(R*38+G*75+B*15)>>7

Gray=(R*76+G*150+B*30)>>8

Gray=(R*153+G*300+B*59)>>9

Gray=(R*306+G*601+B*117)>>10

Gray=(R*612+G*1202+B*234)>>11

Gray=(R*1224+G*2405+B*467)>>12

Gray=(R*2449+G*4809+B*934)>>13

Gray=(R*4898+G*9618+B*1868)>>14

Gray=(R*9797+G*19235+B*3736)>>15

Gray=(R*19595+G*38469+B*7472)>>16

Gray=(R*39190+G*76939+B*14943)>>17

Gray=(R*78381+G*153878+B*29885)>>18

Gray=(R*156762+G*307757+B*59769)>>19

Gray=(R*313524+G*615514+B*119538)>>20

Gray=(R+(WORD)G<<1+B)>>2

Where “WORD” in the last formula above is a double-byte conversion operator; and “<<” in the last formula above is a left shift operator. That is, (WORD) G<<1 refers to converting the single byte “G” to a double byte, and then performing a one-bit left shift on the converted double byte.

Further, the mean value method refers to calculating a mean of the values of the R, G and B components of the pixel and determining a result of the calculation as the first grayscale value of the character. In some embodiments, the first grayscale value of the character is determined according to the RGB value by formula (5) below.

Gray=(R+G+B)/3 (5)

In formula (5), Gray represents the first grayscale of the character, R represents the value of the R component of the pixel, G represents the value of the G component of the pixel and B represents the value of the B component of the pixel.

Moreover, the maximum value method refers to selecting a maximum of the values of the R, G and B components of the pixel as the first grayscale value of the character.

The mean value method and the maximum value method will be understood by those of skill in the related art, and thus further details thereof will be omitted herein.

Operation 203: determining whether the first grayscale value of the character is less than a predefined threshold; in response to the first grayscale value being less than the predefined threshold, performing operation 204, and in response to the first grayscale being greater than or equal to the predefined threshold, performing operation 205.

Here, the dual-screen device obtains a second grayscale value of the frame for the character after determining the first grayscale value of the character according to the RGB value, where the second grayscale value is different from the first grayscale value. In some embodiments, the dual-screen device obtains the second grayscale of the frame by determining whether the first grayscale value is less than the predefined threshold. In some embodiments, the predefined threshold is greater than 128 and less than 255, e.g., the predefined threshold can be approximately 200.

Operation 204: selecting a third grayscale value, greater than the first grayscale value, as the second grayscale value of the frame and performing operation 206.

The first grayscale value is less than the predefined threshold, which indicates a large proportion of black in the character. In this situation, the dual screen device uses a third grayscale value greater than the first grayscale value of the character as the grayscale value of the frame.

For example, the first grayscale value of the character is approximately 0 and the second grayscale value of the frame for the character is approximately 255. In other words, when the first grayscale value of the character is approximately 0, since the first grayscale value is less than the predefined threshold (i.e. approximately 200), the dual-screen device uses a grayscale value approximately 255 as the second grayscale value of the frame, to make sure that the grayscale value difference between the character and the frame is big enough for a user to identify the character instantly.

As another example, when the first grayscale value of the character is approximately 150, since the first grayscale value of the character is less than the preset threshold (i.e. approximately 200), the dual-screen device uses a grayscale value f1 (f1>150) as the second grayscale value of the frame. Where the greater the difference between the grayscale value of the frame and the grayscale value of the character, the easier it is for a user to identify the character displayed on the e-ink screen.

Operation 205: selecting a fourth grayscale value, less than the first grayscale value, as the second grayscale value of the frame and performing operation 206.

The first grayscale value of the character is greater than or equal to the predefined threshold, which indicates a large proportion of white in the character. In this situation, the dual screen device uses a fourth grayscale value less than the first grayscale value of the character as the grayscale value of the frame.

For example, the first grayscale value of the character is approximately 255 and the second grayscale value of the frame for the character is approximately 0. In other words, when the first grayscale value of the character is approximately 255, since the first grayscale value of the character is greater than the predefined threshold (i.e. approximately 200), the dual-screen device uses a grayscale value approximately 0 as the grayscale value of the frame, to make sure that the grayscale value difference between the character and the frame is enough for a user to identify the character instantly.

As another example, when the first grayscale value of the character is approximately 250, since the grayscale value of the character is greater than the predefined threshold (i.e. approximately 200), the dual-screen device uses a grayscale value f2 (f2<150) as the grayscale value of the frame. The greater the difference between the grayscale value of the frame and the grayscale value of the character, the easier it is for a user to identify the character displayed on the e-ink screen.

Operation 206: displaying the character on the e-ink screen according to the first grayscale value and displaying the frame surrounding the character on the e-ink screen according to the second grayscale value.

The dual-screen device displays the character on the e-ink screen according to the first grayscale value and displays the frame surrounding the character on the e-ink screen according to the second grayscale value, so that the grayscale levels of the character and the frame are different. For one example, the first grayscale value of the character is approximately 150, which is less than the predefined threshold (i.e., approximately 200), the dual-screen device takes a grayscale value approximately 255 as the grayscale value of the frame, displays the character on the e-ink screen according to the first grayscale value (i.e. approximately 150), and displays the frame surrounding the character on the e-ink screen according to the second grayscale value (i.e., approximately 255). As another example, the first grayscale value of the character is approximately 250, which is greater than the predefined threshold (i.e., approximately 200), the dual-screen device takes a grayscale value approximately 0 as the grayscale value of the frame, displays the character on the e-ink screen according to the first grayscale value (i.e., approximately 250), and displays the frame surrounding the character on the e-ink screen according to the second grayscale value (i.e., approximately 0).

In some embodiments, the dual-screen device sends a draw command to an open graphics library (OpenGL) interface which is configured to draw and display characters. The draw command carries instructions that instruct the OpenGL interface to draw and display the character on the e-ink screen using the first grayscale value and the frame on the e-ink screen using the second grayscale value.

As an example, after determining that the first grayscale value of the character is less than the predefined threshold and taking the third grayscale value, greater than the first grayscale value of the character, as the second grayscale value, the dual-screen device sends a first draw command to the OpenGL interface; where the first draw command carries instructions that instruct the OpenGL interface to draw and display the character on the e-ink screen using the first grayscale value, and to draw and display the frame surrounding the character on the e-ink screen using the second grayscale value. For example, the first draw command is configured to instruct the OpenGL interface to draw and display the character on the e-ink screen using the first grayscale value approximately 0, and to draw and display the frame on the e-ink screen using the second grayscale value approximately 255. In this case, the grayscale level of the character is black, different from the grayscale level of the frame, which is white, thus making it easier for a user to identify the character. In some embodiments, the OpenGL interface draws the character and frame of the character through a DrawText function and then displays the character through a SurfaceFlinger service. Where the OpenGL interface is a graphical program interface that defines a cross-programming language and cross-platform programming interface specifications; the OpenGL interface is configured to manage and control the drawing and display of the character on different hardware platforms; the DrawText function is configured to output formatted character within a specified area; and the SurfaceFlinger service is configured to draw a user interface (UI) for an Android application. In addition, it shall be noted that, for descriptions of the OpenGL interface, the DrawText function and the SurfaceFlinger service, reference can be made to the related art and details thereof will be omitted herein.

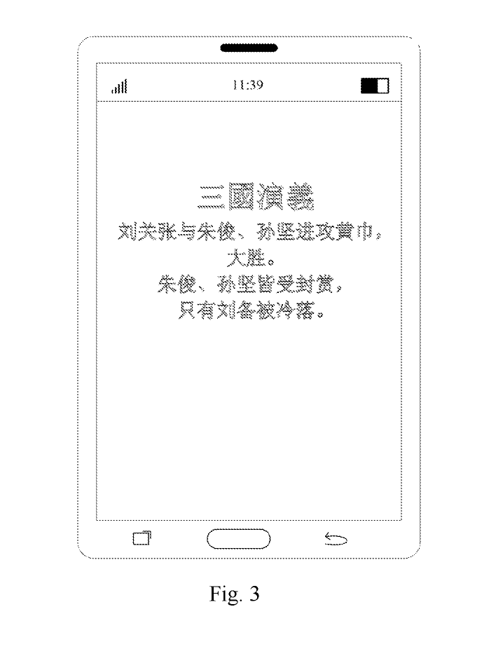

As another example, after determining that the first grayscale value of the character is greater than or equal to the predefined threshold and taking the fourth grayscale value, less than the first grayscale value of the character, as the grayscale value of the frame, the dual-screen device sends a second draw command to the OpenGL interface. The second draw command carries instructions that instruct the OpenGL interface to draw and display the character on the e-ink screen using the first grayscale value, and to draw and display the frame surrounding the character on the e-ink screen using the second grayscale value. For example, the second draw command is configured to instruct the OpenGL interface to draw and display the character on the e-ink screen using the first grayscale value approximately 255, and to draw and display the frame on the e-ink screen using the second grayscale value approximately 0. In this case, as illustrated in FIG. 3, the grayscale level of the character is white, different from the grayscale level of the frame, which is black, thus making it easier for a user to identify the character on the e-ink screen. In some embodiments, the OpenGL interface draws the character and frame of the character through a DrawText function and then displays the character through a SurfaceFlinger service.

It shall be noted that, the order of the operations of the method for displaying the character according to the embodiments of the disclosure may be adjusted if necessary, and an operation may also be added or omitted as required. Any modified version of the method that can be easily thought of by those skilled in the art in view of the technical scope disclosed in the disclosure shall fall within the scope of the present disclosure, so details of these modified versions are not repeated herein.

In the method for displaying the character according to the embodiments of the disclosure, the first grayscale value of the character and the second grayscale value of the frame for the character are obtained, the character is displayed on the e-ink screen according to the first grayscale value and the frame surrounding the character is displayed on the e-ink screen according to the second grayscale value. Since the second grayscale value of the frame is different from the first grayscale value of the character, grayscale levels of the character and the frame are different, avoiding ambiguity of the displayed character caused by similarity or consistency of the grayscale levels of the character and the background color of the e-ink screen, which allow a user to identify the character on the e-ink screen easier.

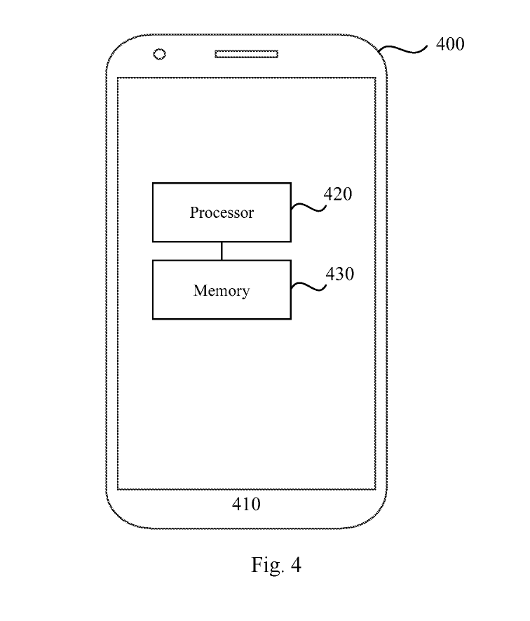

The embodiments of the disclosure further provide a dual-screen device. As illustrated in FIG. 4, the dual-screen device 400 includes a main body 410, a color display screen (not illustrated) on a first surface of the main body 410 and an e-ink screen (not illustrated) on a second surface, opposite to the first surface, of the main body 410. The dual-screen device 400 further includes a processor 420 and a memory 430 storing computer programs, where the processor 420 is configured to execute the computer programs to: obtain an RGB value of a pixel of text displayed on the color display screen; determine a first grayscale value of the text according to the RGB value; determine a second grayscale value of a background for the text, where the second grayscale value is different from the first grayscale value; display the text on the e-ink screen according to the first grayscale value and display the background surrounding the text on the e-ink screen according to the second grayscale value.

In some embodiments, the processor 420 is further configured to execute the computer programs to: determine the first grayscale value of the text according to the RGB value by adopting a weighted average method, a mean value method, or a maximum value method.

In some embodiments, when the first grayscale value of the text is determined via the weighted average method, a weight for the G component is greater than a weight for the R component, and the weight for the R component is greater than a weight for the B component.

In some embodiments, the processor 420 is further configured to execute the computer programs to: determine whether the first grayscale value of the text is less than a predefined threshold; and in response to the first grayscale value being less than the predefined threshold, select a third grayscale value, greater than the first grayscale value, as the second grayscale value of the background; in response to the first grayscale being greater than or equal to the predefined threshold, select a fourth grayscale value, less than the first grayscale value, as the second grayscale value of the background.

In some embodiments, the predefined threshold is greater than 128 and less than 255, e.g., the predefined threshold is approximately 200.

In some embodiments, the first grayscale value is approximately 0 and the second grayscale value is approximately 255. Or, the first grayscale value is approximately 255 and the second grayscale value is approximately 0.

In some embodiments, the processor 420 is further configured to execute the computer programs to: send a draw command to an OpenGL interface which is configured to draw and display the text; where the draw command carries instructions that instruct the OpenGL interface to draw and display the text on the e-ink screen using the first grayscale value and the background on the e-ink screen using the second grayscale value.

The dual-screen device according to the embodiments of the disclosure can obtain the first grayscale value of the text and the second grayscale value of the background for the text, display the text on the e-ink screen according to the first grayscale value and display the background surrounding the text on the e-ink screen according to the second grayscale value. Since the second grayscale value of the background is different from the first grayscale value of the text, grayscale levels of the text and the background are different, avoiding ambiguity of the displayed text caused by similarity or consistency of the grayscale levels of the text and the background color of the e-ink screen, which allow a user to identify the text on the e-ink screen easier.

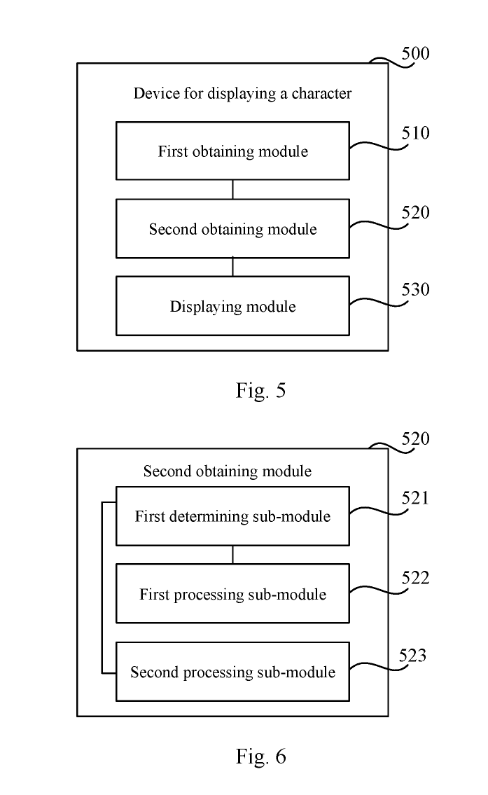

The embodiments of the disclosure further provide a device for displaying text. The device is configured to display the text on a dual-screen device; where the dual-screen device includes a main body, a color display screen on a first surface of the main body and an e-ink screen on a second surface, opposite to the first surface, of the main body. As illustrated in FIG. 5, the device 500 for displaying the text includes a first obtaining module 510, a second obtaining module 520 and a displaying module 530.

The first obtaining module 510 is configured to obtain an RGB value of a pixel of the text displayed on the color display screen and determine a first grayscale value of the text according to the RGB value. The second obtaining module 520 is configured to determine a second grayscale value of a background for the text, where the second grayscale value is different from the first grayscale value. The displaying module 530 is configured to display the text on the e-ink screen according to the first grayscale value and display the background surrounding the text on the e-ink screen according to the second grayscale value.

In some embodiments, as illustrated in FIG. 6, the second obtaining module 520 includes a first determining sub-module 521, a first processing sub-module 522, and a second processing sub-module 523. The first determining sub-module 521 is configured to determine whether the first grayscale value of the text is less than a predefined threshold. The first processing sub-module 522 is configured to select a third grayscale value, greater than the first grayscale value, as the second grayscale value of the background in response to the first grayscale value being less than the predefined threshold. The second processing sub-module 523 is configured to select a fourth grayscale value, less than the first grayscale value, as the second grayscale value of the background in response to the first grayscale being greater than or equal to the predefined threshold.

In some embodiments, the predefined threshold is greater than 128 and less than 255, e.g., the predefined threshold is approximately 200.

In some embodiments, the first grayscale value is approximately 0 and the second grayscale value is approximately 255. Or, the first grayscale value is approximately 255 and the second grayscale value is approximately 0.

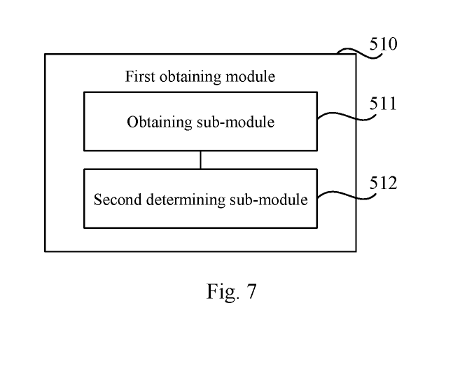

In some embodiments, as illustrated in FIG. 7, the first obtaining module 510 includes an obtaining sub-module 511 and a second determining sub-module 512. The obtaining sub-module 511 is configured to obtain the RGB value of the pixel of the text displayed on the color display screen. The second determining sub-module 512 is configured to determine the first grayscale value of the text according to the RGB value.

In some embodiments, the second determining sub-module 512 is configured to determine the first grayscale value of the text according to the RGB value by adopting a weighted average method, a mean value method, or a maximum value method.

In some embodiments, when the first grayscale value of the text is determined via the weighted average method, a weight for a G component is greater than a weight for an R component, and the weight for the R component is greater than a weight for a B component.

In some embodiments, the displaying module 530 is configured to send a draw command to an OpenGL interface which is configured to draw and display the text. The draw command carries instructions that instruct the OpenGL interface to draw and display the text on the e-ink screen using the first grayscale value and the background on the e-ink screen using the second grayscale value.

The device for displaying the text according to the embodiments of the disclosure can obtain the first grayscale value of the text and the second grayscale value of the background for the text, display the text on the e-ink screen according to the first grayscale value and display the background surrounding the text on the e-ink screen according to the second grayscale value. Since the second grayscale value of the background is different from the first grayscale value of the text, grayscale levels of the text and the background are different, avoiding ambiguity of the displayed text caused by similarity or consistency of the grayscale levels of the text and the background color of the e-ink screen, which allow a user to identify the text on the e-ink screen easier.

Those skilled in the art may clearly understand that, for convenience and brevity of the description, reference can be made to corresponding processes in the foregoing method embodiments for working processes of the foregoing devices and modules, thus details thereof will be omitted herein.

The embodiments of the disclosure further provide a computer readable non-transitory storage medium. The computer readable non-transitory storage medium includes computer codes, where the computer codes are configured to enable a processor of a dual-screen device to execute operations of the method for displaying the text according to the embodiments of the disclosure when the computer codes run on the processor of the dual-screen device; where the dual-screen device includes a main body, a color display screen on a first surface of the main body, and an e-ink screen on a second surface, opposite to the first surface, of the main body.

The embodiments of the disclosure further provide a computer program product including instructions; where the computer program product is configured to enable a computer to execute operations of the method for displaying the text according to the embodiments of the disclosure when the computer program product runs on the computer.

The disclosure is described above with reference to the block diagrams and/or flowcharts illustrating the methods, devices (systems) and/or computer program products according to embodiments of the disclosure. It shall be understood that one or combinations of blocks of the block diagrams and/or flowcharts can be implemented by computer program instructions. These computer program instructions may be provided to a processor of a general purpose computer or of a special purpose computer, and/or to other programmable data processing apparatus to produce a machine such that the instructions executed by the computer processor and/or the other programmable data processing apparatus enact the methods for implementing the functions/operations specified in the block diagrams and/or flowcharts.

Accordingly, the disclosure may also be implemented by hardware and/or software (including firmware, resident software, microcode, etc.). Furthermore, the disclosure may take the form of a computer program product on a computer-usable or computer-readable storage medium having computer-usable or computer-readable program codes embodied in the medium for use by an instruction execution system or to be used in conjunction with the instruction execution system. In the context of the disclosure, a computer-usable or computer-readable medium may be any medium that can contain, store, communicate, transport, or transfer the program for use by an instruction execution system, apparatus or device, or to be used in connection with an instruction execution system, apparatus or device.

Those skilled in the art can make various modifications and variations to the disclosure without departing from the spirit and scope of the disclosure. Thus the disclosure is also intended to encompass these modifications and variations thereto so long as the modifications and variations come into the scope of the claims appended to the disclosure and their equivalents.

What is claimed is:

1. A method for displaying text on a dual-screen device, comprising:
obtaining a red-green-blue (RGB) value of a pixel of the text displayed on a color display screen of the dual-screen device, wherein the dual-screen device comprises a main body, the color display screen on a first surface of the main body, and an e-ink screen on a second surface, opposite to the first surface, of the main body;
determining a first grayscale value of the text according to the RGB value;
determining a second grayscale value of a background for the text, wherein the second grayscale value is different from the first grayscale value; and
displaying the text on the e-ink screen according to the first grayscale value and displaying the background surrounding the text on the e-ink screen according to the second grayscale value.

2. The method according to claim 1, wherein determining the first grayscale value of text according to the RGB value comprises:
determining the first grayscale value of the text according to the RGB value by adopting a weighted average method, a mean value method, or a maximum value method.

3. The method according to claim 2, wherein when the first grayscale value of the text is determined via the weighted average method, a weight for a G component is greater than a weight for an R component, and the weight for the R component is greater than a weight for a B component.

4. The method according to claim 1, wherein determining the second grayscale value of the background for the text comprises:
determining whether the first grayscale value of the text is less than a predefined threshold; and
in response to the first grayscale value being less than the predefined threshold, selecting a third grayscale value, greater than the first grayscale value, as the second grayscale value of the background;
in response to the first grayscale being greater than or equal to the predefined threshold, selecting a fourth grayscale value, less than the first grayscale value, as the second grayscale value of the background.

5. The method according to claim 4, wherein the predefined threshold is greater than 128 and less than 255.

6. The method according to claim 5, wherein the predefined threshold is approximately 200.

7. The method according to claim 1, wherein the first grayscale value is approximately 0 and the second grayscale value is approximately 255.

8. The method according to claim 1, wherein the first grayscale value is approximately 255 and the second grayscale value is approximately 0.

9. The method according to claim 1, wherein displaying the text on the e-ink screen according to the first grayscale value and displaying the background surrounding the text on the e-ink screen according to the second grayscale value comprises:
sending a draw command to an open graphics library (OpenGL) interface which is configured to draw and display the text, wherein the draw command carries instructions that instruct the OpenGL interface to draw and display the text on the e-ink screen using the first grayscale value and the background on the e-ink screen using the second grayscale value.

10. A dual-screen device, comprising a main body, a color display screen on a first surface of the main body, and an e-ink screen on a second surface, opposite to the first surface, of the main body; wherein the dual-screen device further comprises a processor and a memory storing computer programs, and the processor is configured to execute the computer programs to:
obtain a red-green-blue (RGB) value of a pixel of text displayed on the color display screen;
determine a first grayscale value of the text according to the RGB value;
determine a second grayscale value of a background for the text, wherein the second grayscale value is different from the first grayscale value; and
display the text on the e-ink screen according to the first grayscale value and display the background surrounding the text on the e-ink screen according to the second grayscale value.

11. The dual-screen device according to claim 10, wherein the processor is further configured to execute the computer programs to:
determine the first grayscale value of the text according to the RGB value by adopting a weighted average method, a mean value method, or a maximum value method.

12. The dual-screen device according to claim 11, wherein when the first grayscale value of the text is determined via the weighted average method, a weight for a G component is greater than a weight for an R component, and the weight for the R component is greater than a weight for a B component.

13. The dual-screen device according to claim 10, wherein the processor is further configured to execute the computer programs to:
determine whether the first grayscale value of the text is less than a predefined threshold; and
in response to the first grayscale value being less than the predefined threshold, select a third grayscale value, greater than the first grayscale value, as the second grayscale value of the background;
in response to the first grayscale being greater than or equal to the predefined threshold, select a fourth grayscale value, less than the first grayscale value, as the second grayscale value of the background.

14. The dual-screen device according to claim 13, wherein the predefined threshold is greater than 128 and less than 255.

15. The dual-screen device according to claim 14, wherein the predefined threshold is approximately 200.

16. The dual-screen device according to claim 10, wherein the first grayscale value is approximately 0 and the second grayscale value is approximately 255.

17. The dual-screen device according to claim 10, wherein the first grayscale value is approximately 255 and the second grayscale value is approximately 0.

18. The dual-screen device according to claim 10, wherein the processor is further configured to execute the computer programs to:
send a draw command to an open graphics library (OpenGL) interface which is configured to draw and display the text, wherein the draw command carries instructions that instruct the OpenGL interface to draw and display the text on the e-ink screen using the first grayscale value and the background on the e-ink screen using the second grayscale value.

19. The dual-screen device according to claim 10, wherein the text comprises a character or a word.

20. A method for displaying a character on a dual-screen device, comprising:
obtaining a red-green-blue (RGB) value of a pixel of the character displayed on a color display screen of the dual-screen device, wherein the dual-screen device comprises a main body, the color display screen on a first surface of the main body, and an e-ink screen on a second surface, opposite to the first surface, of the main body;
determining a first grayscale value of the character according to the RGB value;
determining a second grayscale value of a frame for the character, wherein the second grayscale value is different from the first grayscale value; and
displaying the character on the e-ink screen according to the first grayscale value and displaying the frame surrounding the character on the e-ink screen according to the second grayscale value.
